(19) United States
(12) Patent Application Publication
(10) Pub. No.: US 2006/0069770 A1
(43) Pub. Date: Mar. 30, 2006

(54) Automatic transmission of messages and processing of responses

(76) Inventor: Frank Stienhans, Mannheim (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/952,350

(22) Filed: Sep. 27, 2004

(51) Int. Cl. G06F 15/173

(52) U.S. Cl. 709/224

(57) ABSTRACT

Methods and apparatus, including computer program products, for transmitting a message upon the detection of a predetermined event and performing an action associated with a predetermined option indicated by a received response. Upon detecting a predetermined event in a system, an asynchronous message based upon the detected predetermined event is automatically transmitted to a recipient. The asynchronous message includes a set of predetermined options for responding to the detected predetermined event. Upon receiving a response to the asynchronous message, an action associated with a selected option is performed. A rules set can be used to determine whether to transmit a message upon detecting a predetermined event, the message content, the included set of predetermined options, a recipient to whom the message should be transmitted, and a recipient address.

### FIELD OF THE INVENTION

The present invention relates to data processing by digital computer, and more particularly to automated notification systems.

### BACKGROUND

Communication between humans and computers is primarily limited by syntax. In general, a computer is constrained by the set of instructions it can correctly interpret and the set of responses it has been programmed to provide. Although input and output can be performed using a variety of common means, the data being input and output must conform to a format the computer is able to process. Therefore, human-computer interaction has typically been conducted through the use of an interface designed to facilitate clear and concise communication, such as a graphical user interface.

A human-machine interface permits a human operator to enter a command in such a way that a computer, or an application program being executed on a computer, is able to receive and interpret the command without ambiguity. Using such an interface, a human and a computer can interact in real time, with the computer receiving information provided by the human and subsequently outputting corresponding results. However, limiting the commands that can be input to a computer is not always convenient for computer users. Moreover, because humans and computers typically interact through an interface, most such communication must be conducted synchronously.

In contrast, humans have been using computers as a medium for asynchronous communication with one another for almost as long as computers have been in use. In a typical scenario, a human sender composes an electronic message and transmits it to a human recipient, using a system of interconnected computers. The recipient subsequently reads and processes the electronic message at her convenience. If desired, the recipient may then generate an additional electronic message and respond to the sender. Because humans have the ability to process a broad range of information, there are very few constraints placed on the organization of data contained in such electronic messages. The ability to communicate with minimal constraints on organization has also allowed humans to communicate with one another using synchronous means. In general, electronic communication between humans (including both synchronous and asynchronous communication) has taken a variety of forms, including electronic mail (e-mail), instant messages, and text messages.

Although humans can communicate with one another using free text instead of the narrowly defined syntax required for human-computer communication, humans are often constrained by time. While a computer may parse an instruction in as little as a few processing cycles, it may take a human several minutes to open a message, process the information it contains, and then carry out the requested action. In many instances, humans simply do not have sufficient time to perform all of the tasks required of them.

### SUMMARY OF THE INVENTION

The present invention provides methods and apparatus, including computer program products, that implement techniques for providing an automated notification system that allows responses to be processed automatically.

In general, in one aspect, the techniques feature detecting a predetermined event in a system, automatically transmitting an asynchronous message based upon the detected predetermined event, wherein the asynchronous message includes a set of predetermined options for responding to the detected predetermined event, receiving a response to the asynchronous message indicating a selected option from the set of predetermined options, and performing an action associated with the selected option.

The techniques can be implemented to include structuring the asynchronous message as an e-mail message or a text message. The techniques can also be implemented to include identifying a rule in a rule set based on the detected predetermined event. The techniques can further be implemented to determine the set of predetermined options to include in the asynchronous message based on the identified rule. Additionally, the techniques can further be implemented to determine a recipient to whom the asynchronous message is to be transmitted based on the identified rule. The techniques can also be implemented to select one or more addresses associated with a recipient when determining a recipient to whom the asynchronous message is to be transmitted.

The techniques can also be implemented such that the asynchronous message is composed based on the identified rule. Further, the techniques can be implemented to include selecting a predetermined message from a set of predetermined messages. Further still, the techniques can be implemented to include selecting a predetermined message from a set of predetermined messages associated with the detected predetermined event. Additionally, the techniques can be implemented to include indicating, by the identified rule, one or more conditions in which to transmit an asynchronous message, and automatically transmitting the asynchronous message only if the conditions are true.

The techniques can also be implemented to include detecting a predetermined event that is a change in an application configuration. The techniques can also be implemented to include detecting a predetermined event that is the availability of an application patch. Further, the techniques can also be implemented to include having the set of predetermined options comprise an option to install an application patch and an option not to install an application patch. Additionally, the techniques can be implemented to include the detected predetermined event comprising a commercial transaction.

In general, in another aspect, the techniques can be implemented using a computer for detecting a predetermined event in a system, automatically transmitting an asynchronous message based upon the detected predetermined event, wherein the asynchronous message includes a set of predetermined options for responding to the detected predetermined event, receiving a response to the asynchronous message indicating a selected option from the set of predetermined options, and performing an action associated with the selected option.

In general, in another aspect, the techniques can include a means for detecting a predetermined event in a system, a means for automatically transmitting an asynchronous message based upon the detected predetermined event, wherein the asynchronous message includes a set of predetermined options for responding to the detected predetermined event, a means for receiving a response to the asynchronous message indicating a selected option from the set of predetermined options, and a means for performing an action associated with the selected option.

The techniques described in this specification can be used to realize one or more of the following advantages. The techniques can be used to implement an automated notification system that allows responses to be processed automatically. Such a system can reduce an administrator's workload by eliminating the need for an administrator to respond to tasks that can be automated. Such a system can also decrease the number of interruptions to an administrator or user by allowing electronic messages to be processed at the recipient's convenience. Further, by automatically executing received instructions, such a system can improve the performance of a computer system with which it is associated. Additionally, by making it more convenient to implement software revisions and updates, such a system can increase the security and stability of a computer system with which it is associated. Further, such a system can also optimize the integration of configuration changes by automatically executing such changes at a specified time. The advantages described above, taken together or individually, serve to reduce the total cost of ownership of an associated computer system. One implementation of the invention provides all of the above advantages.

These general and specific aspects can be implemented using a computer program, a method, a system or apparatus, or any combination of computer programs, methods, or systems. The details of one or more implementations of the invention are set forth in the accompanying drawings and the description below. Further features, aspects, and advantages of the invention will become apparent from the description, the drawings, and the claims.

### BRIEF DESCRIPTION OF THE DRAWINGS

FIGS. 1-2 are block diagrams showing communication between humans and computers.

FIGS. 3-4 are block diagrams of systems of distributed computers.

FIG. 5 is a flow diagram describing a process a computer can use to determine whether to transmit an electronic message.

FIG. 6 is a flow diagram describing a process a computer can use to determine whether to perform an action indicated by a received electronic response.

FIG. 7 illustrates a flowchart for an automated notification system that allows responses to be processed automatically.

Like reference numbers and designations in the various drawings indicate like elements.

### DETAILED DESCRIPTION

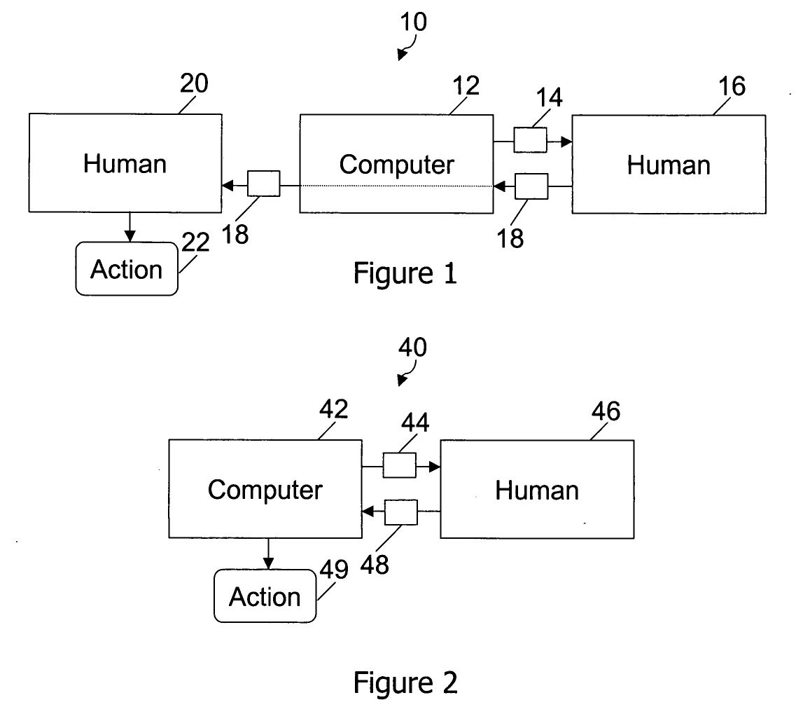

As shown in FIG. 1, a system 10 that initiates a communication between a computer or program and a first human typically relies on a second human to complete the communication. In the system 10, a monitoring computer or program 12 is configured to detect the occurrence of one or more predetermined events and to initiate communication with a first human 16 upon detecting the occurrence of one of the predetermined events. The monitoring computer or program 12 initiates communication with the first human 16 by transmitting an electronic message 14. Because an immediate response is not required, the monitoring computer or program 12 transmits the electronic message 14 using an asynchronous form of communication, such as electronic mail.

The first human 16 can then open the electronic message 14 and process the information it contains at any time after it has been received. After processing the electronic message 14, the first human 16 can then transmit an electronic response 18 to the monitoring computer or program 12. This electronic response 18 can indicate an action the first human 16 desires to have executed in response to the electronic message 14. However, instead of processing the first human's electronic response 18, the monitoring computer or program 12 forwards the electronic response 18 to a second human 20. It is the second human 20 who ultimately processes the electronic response 18 and executes the action 22 indicated therein.

In this system 10, a cost savings in terms of human work hours is realized by having the monitoring computer or program 12 initiate communication with the first human 16 upon the detection of the predetermined event. Automating this process eliminates the need to have a human perform the detecting function. However, as the electronic response 18 sent to monitoring computer or program 12 must be processed by the second human 20, only a partial cost savings is realized.

In another implementation, a system can perform a variation of the process described with respect to FIG. 1. As described above, the monitoring computer or program transmits an electronic message to a first human. Because an immediate response is not required, the monitoring computer or program transmits the electronic message using an asynchronous form of communication, such as electronic mail. After receiving the electronic message, the first human can then process the message at a time that is convenient. The first human can then transmit an electronic response, indicating an action the first human desires to be executed in response to the electronic message. However, unlike the process described in relation to FIG. 1, when the first human transmits an electronic response, the response is routed directly to a second human, who processes the electronic response and executes the action indicated therein. This can be accomplished by embedding the second human's address in the electronic message as the reply-to address. Thus, the monitoring computer or program must know the second human's address before transmitting the electronic message. In this system, a cost savings in terms of human work hours is realized by having the monitoring computer or program initiate communication with the first human upon the detection of the predetermined event. As described above, however, the electronic response must be processed by the second human and therefore only a partial cost savings is achieved.

As shown in FIG. 2, in another implementation, a system 40 includes a monitoring computer or program 42 that, upon detecting a predetermined event, initiates communication with a human 46 by transmitting an electronic message 44. The electronic message 44 indicates that a predetermined event has been detected and includes a set of predetermined options that can be used in responding to the message. The set of predetermined options includes one or more predetermined options, each of which can be associated with an action. Because an immediate response is not required, the electronic message 44 can be transmitted using an asynchronous form of communication, such as electronic mail. The human 46 subsequently receives the electronic message 44 and can process it at a convenient time.

However, unlike the system of FIG. 1, when the human 46 transmits an electronic response 48 to the electronic message 44, the monitoring computer or program 42 receives and processes the electronic response 48. This is possible because the human 46 can use the set of predetermined options included in the electronic message 44 in preparing a response. The monitoring computer or program 42 examines the received electronic response 48 to determine whether a predetermined option is indicated, and then executes an action 49 associated with each indicated predetermined option.

Because the electronic message 44 includes one or more predetermined options that can be indicated in the electronic response 48, there is no need for the monitoring computer or program 42 to analyze the electronic response 48 in order to derive the response information. The monitoring computer or program 42 can automatically determine response information based on an indicated predetermined option. For example, an electronic mail message can be transmitted upon the detection of a new software patch and can include predetermined options that can be selected by a recipient, such as ‘INSTALL’ and ‘DO NOT INSTALL’. Upon receiving an electronic response to this message, the monitoring computer or program can automatically determine whether the predetermined option ‘INSTALL’ or ‘DO NOT INSTALL’ has been indicated, and can perform an action associated with the indicated predetermined option.

In this system 40, a cost savings in terms of human work hours is realized by having the monitoring computer or program 42 initiate communication with the human 46 upon the detection of a predetermined event. However, additional human work hours are also saved by having the monitoring computer or program 42 receive and process the human's electronic response 48, as well as execute the action 49 indicated therein. In the system 40, a human is only required to decide whether an action must be taken in response to the electronic message 44 transmitted by the monitoring computer or program 42 and, if so, to transmit an electronic response 48 indicating a predetermined option associated with an action the human desires to have executed.

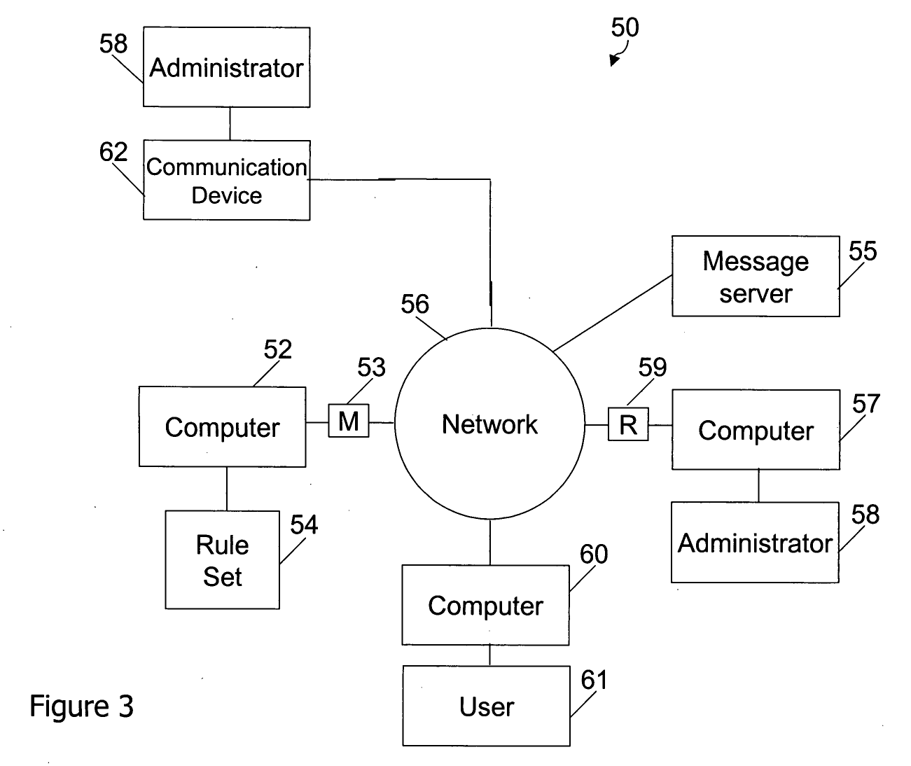

Referring to FIG. 3, the human-computer communication described with respect to FIG. 2 is now describe with reference to a system of distributed computers 50. A monitoring computer or program 52 is configured to monitor one or more objects in the system of distributed computers 50 in order to detect the occurrence of a predetermined event. A monitored object can be, for example, a computer, a workstation, a server, a router, a switch, a hub, a modem, a communication pathway, or an application program. The monitoring computer or program 52 is configured to detect one or more predetermined events that can occur in the system of distributed computers 50, wherein each predetermined event comprises one or more criteria which may be objectively evaluated. For example, a “software update” predetermined event can be associated with the receipt of an executable file or an updated configuration file (or a message containing a hyperlink to such a file from an address associated with a specific vendor).

Upon detecting the occurrence of a predetermined event, monitoring computer or program 52 evaluates whether to transmit an electronic message 53. In evaluating whether to transmit an electronic message, monitoring computer or program 52 can be configured to interact with a rule set 54 (e.g., through the use of a rule engine). In the implementation shown in FIG. 3, the rule set 54 is depicted as being local to monitoring computer or program 52; however, it is possible for a rule set to be hosted at any address to which the monitoring computer or program 52 has access. In the rule set 54, one or more rules are associated with each of the one or more predetermined events.

In one implementation, the monitoring computer or program 52 interfaces with the rule set 54 when the monitoring computer or program 52 detects the occurrence of a predetermined event. The monitoring computer or program 52 utilizes the rule set 54 to first determine whether to transmit an electronic message 53 in response to the detected predetermined event. If the monitoring computer or program 52 determines that it is to transmit an electronic message 53, the rule set 54 can be used to specify additional information. For example, the rule set 54 can be used to determine one or more predetermined options which are to be included in the electronic message 53. The recipient of the electronic message 53 can then use the included predetermined options to indicate one or more desired actions to the monitoring computer or program 52. Further, rule set 54 can specify any additional information that should be included in the electronic message 53. Such additional information can include a textual description of the detected predetermined event, instructions to the recipient of the electronic message 53, a media file containing additional information, and the contact information of a human representative capable of providing advanced support.

Further, the rule set 54 can provide a list of recipients to whom the electronic message 53 should be sent. As the monitoring computer or program 52 can be configured to detect a plurality of predetermined events and the electronic messages associated with those predetermined events can be sent to various different recipients, it can be advantageous to maintain a list of recipients with whom a subset of predetermined messages is associated. Additionally, the rule set 54 can be configured to specify a plurality of addresses for each recipient. Because a predetermined event may be detected at any time, the rule set 54 can be configured to specify which recipient addresses to use for an electronic message based on the time and date on which the predetermined event is detected and the electronic message is to be sent. For example, if a predetermined event is detected at night, on a weekend, or on a holiday, the electronic message 53 can be transmitted to a recipient's alternate addresses in addition to the recipient's primary address. In this implementation, a recipient may choose to identify one or more alternate addresses for the sake of convenience, such as a personal e-mail account or the phone number of a pager or cellular phone capable of receiving text messages.

Once the monitoring computer or program 52 has interfaced with the rule set 54 and prepared the electronic message 53, the monitoring computer or program 52 transmits the electronic message 53 over a network 56, such as a local area network or the Internet, to the one or more recipient addresses. For example, in one embodiment, if the monitoring computer or program 52 detects a predetermined event associated with the availability of a new security patch for an application program hosted on a server in the distributed system of computers 50, the monitoring computer or program 52 can transmit an electronic message containing the appropriate predetermined options over the network 56 to a message server 55 that stores messages associated with the address of a system administrator 58.

Using a computer 57, the system administrator 58 can access the message server 55 and retrieve the electronic message 53. The system administrator 58 can then process the electronic message 53 and select one or more of the predetermined options included therein, such as a predetermined option indicating that the new security patch should be installed. The system administrator 58 can then transmit the electronic response 59. In this implementation, the monitoring computer or program 52 receives and processes the electronic response 59. Upon receiving the electronic response 59 indicating one or more predetermined options, the monitoring computer or program 52 executes the action associated with each of the indicated predetermined options, such as installing the new security patch. In other implementations, the electronic response 59 can be directed to a computer or program other than the monitoring computer or program.

As discussed above, the monitoring computer or program 52 may also include in the electronic message 53 an alternate address associated with the system administrator 58. For example, if the electronic message 53 is transmitted at a time the system administrator 58 is not at work, the system administrator 58 can access the message at the alternate address. In this example, the system administrator 58 uses a communication device 62, which is also connected to the network 56, to retrieve and process the message. The communication device 62 can be connected to the network 56 directly, such as through a remote access server or modem, or indirectly, such as through the Internet.

In another embodiment, the monitoring computer or program 52 can detect a predetermined event associated with a change in a configuration for an application program hosted on one or more servers in the distributed system of computers 50. As discussed above, the monitoring computer or program 52 can transmit an electronic message containing the appropriate predetermined options over the network 56 to a message server 55, which stores messages associated with the address of a system administrator 58. In this example, the electronic message can contain a predetermined option to allow the system administrator 58 to, for example, accept and deploy the revised configuration for the application.

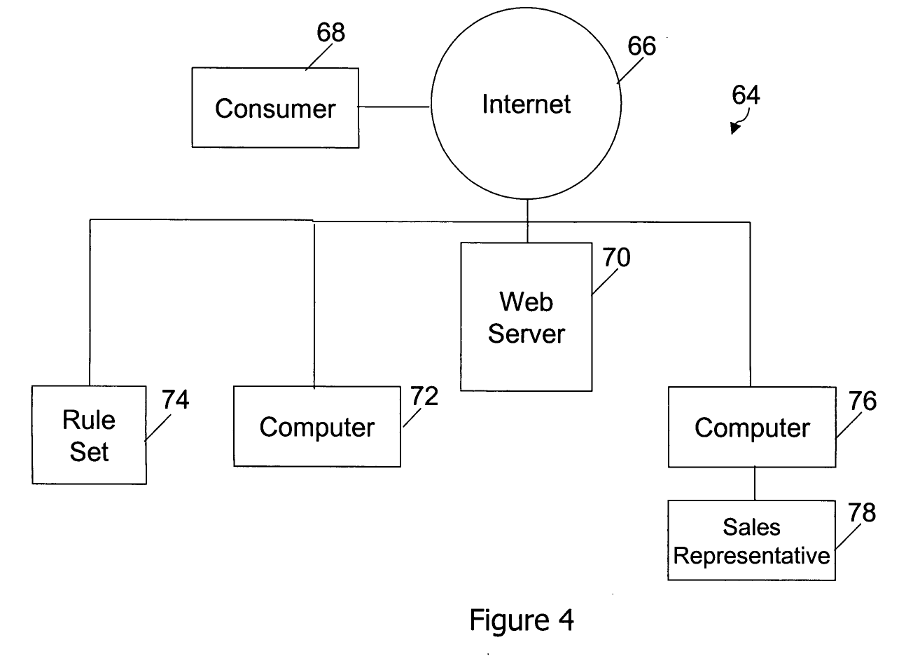

Referring to FIG. 4, in one implementation, computer initiated communication is described in relation to an electronic commerce (e-commerce) system 64. In the e-commerce system 64, a consumer 68 engages in a commercial transaction over the Internet 66 with a merchant web server 70 to purchase a product, such as a book. A monitoring computer or program 72 configured to detect the occurrence of one or more predetermined events monitors the web server 70. Upon detecting the occurrence of a predetermined event, the monitoring computer or program 72 determines whether to transmit an electronic message to a human recipient. As discussed above, in order to determine whether to transmit a message and, if so, how the message should be configured, the monitoring computer or program 72 may interface with a rule set 74.

For example, a merchant may establish several criteria that a consumer must meet in order to be eligible for a reward, such as a free book. These criteria can include objective measures, such as purchasing ten books in one month, and subjective measures, such as a determination by a sales representative that the consumer account is in good standing. The monitoring computer or program 72 can then be configured to detect the objective measures.

In the present example, the monitoring computer or program 72 is configured to detect the occurrence of a tenth-book predetermined event, comprising a consumer placing an order for a tenth book within a one-month period. Upon detecting the occurrence of a tenth-book predetermined event, the monitoring computer or program 72 interfaces with the rule set 74. Using the rule set 74, the monitoring computer or program 72 determines that an electronic message is to be sent in response to the detected tenth-book predetermined event. As in the previous example, the monitoring computer or program 72 can in some implementations further determine which predetermined options to include in the electronic message, whether to include additional information, the identity of one or more recipients to whom the electronic message is to be sent, and one or more addresses corresponding to each recipient. The electronic message of the present example includes a predetermined option to indicate that a free book is to be awarded and a predetermined option to indicate that a free book is not to be awarded. Further, a sales representative 78 is identified as the recipient of the electronic message and a sales representative address is included in the message.

The monitoring computer or program 72 then transmits the electronic message to the address associated with the sales representative 78. Based on the number of qualifying consumers, the sales representative 78 may receive a high volume of electronic messages from the monitoring computer or program 72. Therefore, the monitoring computer or program transmits the electronic message using an asynchronous form of communication, such as electronic mail. The sales representative 78 uses a computer 76 to receive the electronic message at a convenient time. After processing the electronic message, the sales representative 78 transmits an electronic response to the monitoring computer or program 72 indicating an included predetermined option. If the sales representative 78 determines the consumer account is in good standing, the sales representative indicates the predetermined option associated with awarding a free book. Otherwise, the sales representative 78 indicates the predetermined option associated with declining to award a free book. Upon receiving the electronic response, the monitoring computer or program 72 determines which predetermined option has been indicated and executes the action associated with that option (e.g., sending the consumer a coupon code good for the purchase of a free book). As indicated above, the electronic response can alternatively be received and processed by a computer or program other than the monitoring computer or program 72.

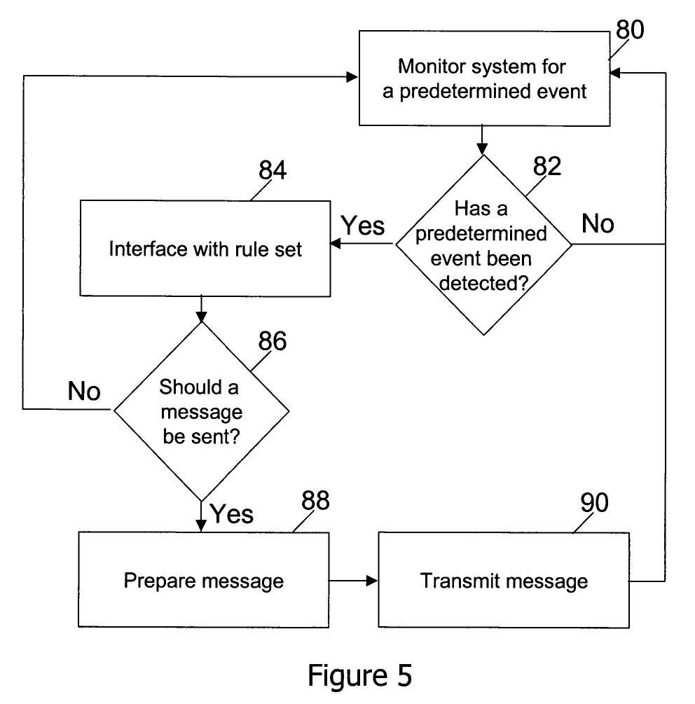

FIG. 5 depicts a flow diagram that describes an example process a monitoring computer or program can use to determine whether to transmit a message. The monitoring computer or program first monitors one or more objects in a system (80). The monitoring computer or program then determines whether a predetermined event has been detected (82). If no predetermined event has been detected, the monitoring computer or program continues to monitor the system objects. If a predetermined event has been detected, the monitoring computer or program interfaces with a rule set (84). Upon interfacing with the rule set, the monitoring computer or program determines whether an electronic message should be transmitted (86). If an electronic message should not be transmitted, the monitoring computer or program continues to monitor one or more objects in the system (80). If an electronic message should be transmitted, the monitoring computer or program prepares the message (88). In preparing the message (88), the monitoring computer or program interfaces with the rule set to determine which predetermined options to include in the electronic message, any additional information to include in the electronic message, one or more recipients to whom the electronic message is to be sent, and one or more addresses for each recipient. Once the electronic message has been prepared, the monitoring computer or program transmits the electronic message (90) and resumes monitoring one or more objects in the system (80).

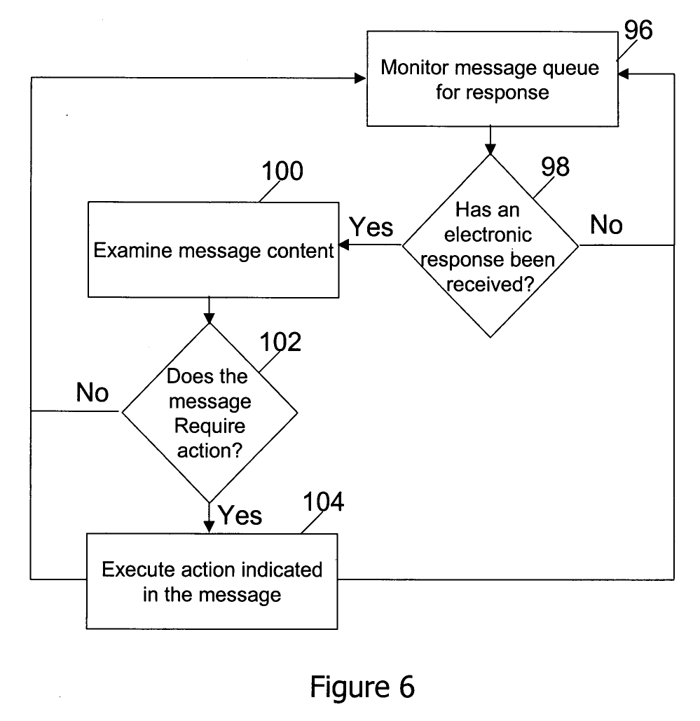

FIG. 6 depicts a flow diagram that describes an example process a monitoring computer or program can use to determine whether to perform an action indicated by a received electronic response. The monitoring computer or program first monitors its message queue for the arrival of an electronic response (96). The monitoring computer or program then determines whether an electronic response has been received (98). If no electronic response has been received, the monitoring computer or program continues to monitor its message queue for the arrival of an electronic response (96). If an electronic response has been received, the monitoring computer or program examines the content of the electronic response (100). Upon examining the content of the electronic response, the monitoring computer or program determines whether an action is required (102). As discussed above, the monitoring computer or program can automatically determine response information based on an indicated predetermined option. The monitoring computer or program is therefore not required to analyze the electronic response in order to determine response information. If no action is required, the monitoring computer or program returns to monitoring its message queue for the arrival of an electronic response (96). If the electronic response contains information indicating one or more predetermined options that require an action, the monitoring computer or program executes the action required by each indicated predetermined option (104) and then returns to monitoring its message queue for the arrival of an electronic response (96).

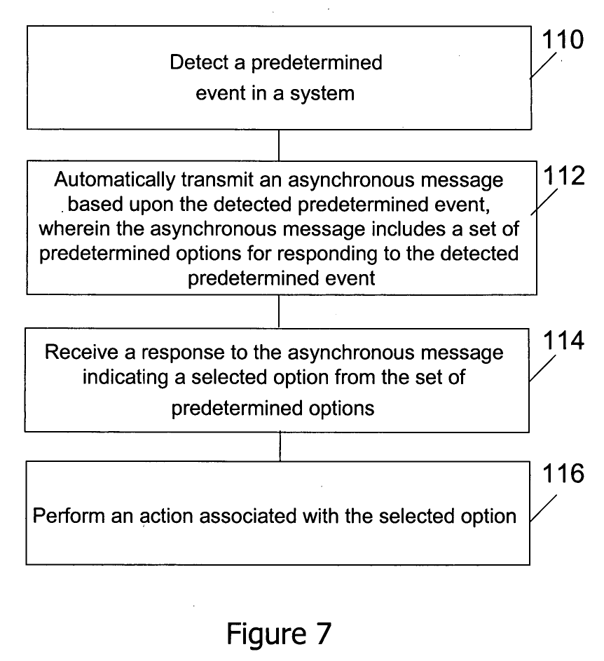

FIG. 7 describes a method of providing automated notification and processing responses automatically. The occurrence of a predetermined event is first detected in a system (110). An asynchronous message based on the detected predetermined event is automatically transmitted (112), wherein the asynchronous message includes a set of predetermined options for responding to the detected predetermined event. A response to the asynchronous message is subsequently received, indicating a selected option from the set of predetermined options (114). After receiving the response to the asynchronous message, an action associated with a selected predetermined option is performed (116).

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A computer program product, stored on a machine-readable medium, the computer program product comprising instructions operable to cause data processing apparatus to:
detect a predetermined event in a system;
automatically transmit an asynchronous message based upon the detected predetermined event, wherein the asynchronous message includes a set of predetermined options for responding to the detected predetermined event;
receive a response to the asynchronous message indicating a selected option from the set of predetermined options; and
perform an action associated with the selected option.

2. The computer program product of claim 1, wherein the asynchronous message is an e-mail message or a text message.

3. The computer program product of claim 1, wherein the instructions are further operable to cause the data processing apparatus to:
identify a rule in a rule set based on the detected predetermined event.

4. The computer program product of claim 3, wherein the instructions are further operable to cause the data processing apparatus to:
determine the set of predetermined options to include in the asynchronous message based on the rule.

5. The computer program product of claim 3, wherein the instructions are further operable to cause the data processing apparatus to:
determine a recipient to whom the asynchronous message is to be transmitted based on the rule.

6. The computer program product of claim 5, wherein there are multiple addresses associated with the recipient, and wherein determining the recipient comprises selecting one or more of the multiple addresses.

7. The computer program product of claim 3, wherein the instructions are further operable to cause the data processing apparatus to:
compose the asynchronous message based on the rule.

8. The computer program product of claim 7, wherein composing the asynchronous message comprises selecting a predetermined message from a set of predetermined messages.

9. The computer program product of claim 8, wherein the set of predetermined messages is associated with the detected predetermined event.

10. The computer program product of claim 3, wherein the rule indicates one or more conditions in which to transmit the asynchronous message, and wherein automatically transmitting the asynchronous message occurs only if the conditions are true.

11. The computer program product of claim 1, wherein the detected predetermined event is a change in an application configuration.

12. The computer program product of claim 1, wherein the detected predetermined event is availability of an application patch.

13. The computer program product of claim 12, wherein the set of predetermined options comprises an option to install the application patch and an option not to install the application patch.

14. The computer program product of claim 1, wherein the detected predetermined event is a commercial transaction.

15. A computer-implemented method comprising:
detecting a predetermined event in a system;
automatically transmitting an asynchronous message based upon the detected predetermined event, wherein the asynchronous message includes a set of predetermined options for responding to the detected predetermined event;
receiving a response to the asynchronous message indicating a selected option from the set of predetermined options; and
performing an action associated with the selected option.

16. An apparatus comprising:
means for detecting a predetermined event in a system;
means for automatically transmitting an asynchronous message based upon the detected predetermined event, wherein the asynchronous message includes a set of predetermined options for responding to the detected predetermined event;
means for receiving a response to the asynchronous message indicating a selected option from the set of predetermined options; and
means for performing an action associated with the selected option.
